(19) United States
(12) Patent Application Publication
(10) Pub. No.: US 2025/0326913 A1
(43) Pub. Date: Oct. 23, 2025

(54) CONDUCTIVE POLYMER COMPOSITE

(71) Applicant: SENERGY INNOVATIONS LIMITED, Belfast, Antrim (GB)

(72) Inventors: Christine Boyle, Belfast (GB); Findhan Strain, Belfast (GB); Niall McGonigle, Belfast (GB); Tony McNally, Belfast (GB); Sandeep Kumar, Belfast (GB)

(73) Assignee: SENERGY INNOVATIONS LIMITED, Belfast, Antrim (GB)

(21) Appl. No.: 18/710,911

(22) PCT Filed: Nov. 17, 2022
(86) PCT No.: PCT/GB2022/052923

§ 371 Date: May 16, 2024

(30) Foreign Application Priority Data
Nov. 18, 2021 (GB) 2116664.0

(51) Int. Cl. C08K 3/04

(52) U.S. Cl. CPC C08K 3/042; C08K 2201/001; C08K 2201/005; C08K 2201/006

(57) ABSTRACT

The present invention relates to composites comprising graphitic carbon dispersed within a polymer matrix. The composites have high thermal conductivities and are particularly useful in solar thermal collectors and other heat exchangers.

The present invention relates to composites comprising graphitic carbon dispersed within a polymer matrix. The composites have high thermal conductivities and are particularly useful in solar thermal collectors and other heat exchangers.

### BACKGROUND

Polymer composites comprising thermally conductive filler materials offer new possibilities for replacing metal parts in applications such as thermal collectors. Polymer composites are light weight and therefore easier to install and handle than their metal counterparts. The filler material dispersed within the polymer matrix may be carefully selected to ensure efficient and effective infra-red absorption and/or thermal conduction.

Polyphthalamides (PPA) are a class of polyamide polymer that have improved chemical resistance and UV-stability compared to other polymers, including other polyamides.

Graphitic forms of carbon, such as graphite and graphene, possess high thermal conductivities.

### SUMMARY OF THE INVENTION

In a first aspect of the invention, there is provided a composite comprising a polyphthalamide (PPA) matrix and graphitic carbon dispersed within the PPA matrix.

The inventors have found that composites of the first aspect demonstrate good thermal conductivity. The inventors have found that using PPA in place of other polyamides can provide an equivalent level of conductivity at lower loadings of graphitic carbon.

The graphitic carbon may be graphite. The graphite may be expanded graphite. The graphite may be surface enhanced flake graphite.

The surface area of the graphite may be >10 m²/g. The surface area of the graphite may be >12 m²/g. The surface area of the graphite may be >15 m²/g. The surface area of the graphite may be in the range from 10 to 50 m²/g. The surface area of the graphite may be in the range from 12 to 40 m²/g, e.g. 15 to 30 m²/g. The surface area of the graphite may be in the range from 20 to 40 m²/g, e.g. 20 to 30 m²/g.

The average particle size of the graphite (e.g. the D₅₀) may be <250 μm. The average particle size of the graphite (e.g. the D₅₀) may be in the range from 100 μm to 250 μm. The average particle size of the graphite (e.g. the D₅₀) may be in the range from 150 μm to 200 μm. The average particle size of the graphite (e.g. the D₅₀) may be <100 μm, e.g., <75 μm. The average particle size of the graphite (e.g. the D₅₀) may be <50 μm. The average particle size of the graphite (e.g. the D₅₀) may be in the range from 150 μm to 250 μm, e.g. from 175 μm to 225 μm.

It may be that greater than 50% by weight (e.g., greater than 75%, greater than 90%, or greater than 98% by weight) of the graphite has a particle size of <250 μm. It may be that greater than 50% by weight (e.g., greater than 75%, greater than 90%, or greater than 98% by weight) of the graphite has a particle size in the range from 100 μm to 250 μm. It may be that greater than 50% by weight (e.g., greater than 75%, greater than 90%, or greater than 98% by weight) of the graphite has a particle size in the range from 150 μm to 200 μm. It may be that greater than 50% by weight (e.g., greater than 75%, greater than 90%, or greater than 98% by weight) of the graphite has a particle size <100 μm, e.g., <75 μm. It may be that greater than 50% by weight (e.g., greater than 55% by weight) of the graphite has a particle size of <50 μm. It may be that greater than 50% by weight (e.g., greater than 75%, greater than 90%, or greater than 98% by weight) of the graphite has a particle size in the range from 150 μm to 250 μm, e.g. from 175 μm to 225 μm.

The average thickness of the graphite may be <100 nm. The average thickness of the graphite may be <50 nm. The average thickness of the graphite may be in the range from 10 to 100 nm, e.g. 15 to 45 nm.

It may be that greater than 50% by weight (e.g. greater than 75%, greater than 90% or greater than 98% by weight) of the graphite has a thickness <100 nm. It may be that greater than 50% by weight (e.g. greater than 75%, greater than 90% or greater than 98% by weight) of the graphite has a thickness <50 nm. It may be that greater than 50% by weight (e.g. greater than 75%, greater than 90% or greater than 98% by weight) of the graphite has a thickness in the range from 10 to 100 nm, e.g. from 15 to 45 nm.

The graphitic carbon may be graphene. The graphitic carbon may comprise graphene.

It may be that the composite comprises graphite and graphene dispersed within the PPA matrix. In these embodiments, the average particle size of the graphene (e.g. the D_{V}50) may be >1 μm, e.g. >10 μm. The average particle size of the graphene (e.g. the D_{V}50) may be <200 μm, e.g. <75 μm. It may be that the average particle size of the graphene (e.g. the D_{V}50) is between 10 μm and 60 μm. The average particle size of the graphene (e.g. the D_{V}50) may between 40 μm and 60 μm, e.g. between 45 μm and 55 μm.

It may be that the oxygen content in the graphene is >2 wt %, e.g., >5 wt %. It may be that the oxygen content in the graphene is <50 wt % e.g., <35 wt %.

The graphene may be pristine graphene, e.g. that which has been directly exfoliated from graphite. The graphene may be reduced graphene oxide. It may be that the graphene is functionalised graphene. It may be that the graphene is graphene nanoplatelets.

In embodiments where the composite comprises graphite and graphene dispersed within the PPA matrix, it may be that greater than 50% by weight (e.g., greater than 75%, greater than 90% or greater than 98% by weight) of the graphene has a particle size of >1 μm, e.g. >10 μm. It may be that greater than 50% by weight (e.g., greater than 75%, greater than 90% or greater than 98% by weight) of the graphene has a particle size of <200 μm, e.g. <75 μm. It may be that greater than 50% by weight (e.g., greater than 75%, greater than 90% or greater than 98% by weight) of the graphene has a particle size of between 10 μm and 60 μm. It may be that greater than 50% by weight (e.g., greater than 75%, greater than 90% or greater than 98% by weight) of the graphene has a particle size of between 40 μm and 60 μm, e.g. between 45 μm and 55 μm.

In embodiments where the composite comprises graphite and graphene dispersed within the PPA matrix, it may be that the wt % of the graphene in the PPA matrix is <15%. It may be that the wt % of the graphene in the PPA matrix is <10%. It may be that the wt % of the graphene in the PPA matrix is from 2% to 8%, e.g. from 3% to 7%.

It may be that the wt % of the graphitic carbon, e.g. graphite, in the PPA matrix is <70 wt %. It may be that the wt % of the graphitic carbon, e.g. graphite, in the PPA matrix is <50 wt %. It may be that the wt % of the graphitic carbon, e.g. graphite, in the PPA matrix is >15 wt %. It may be that the wt % of the graphitic carbon, e.g. graphite, in the PPA matrix is in the range from 25 wt % to 70 wt %. It may be that the wt % of the graphitic carbon, e.g. graphite, in the matrix is in the range from 20 wt % to 55 wt %, e.g. from 25 wt % to 50 wt %. It may be that the wt % of the graphitic carbon, e.g. graphite, in the PPA matrix is from 20% to 40%, e.g. from 25% to 35%. It may be that the wt % of the graphitic carbon, e.g. graphite, in the PPA matrix is <30%. It may be that the wt % of the graphitic carbon, e.g. graphite, in the PPA matrix is from 5% to 25%, e.g. from 10% to 20%.

It may be that the wt % of the PPA matrix is from 50 wt % to 90 wt %. It may be that the wt % of the PPA matrix is from 55 wt % to 75 wt %. Alternatively, it may be that the wt % of PPA matrix is from 75 wt % to 85 wt %.

It may be that the PPA matrix in which the graphitic carbon is dispersed consists of >75 wt % PPA. It may be that the PPA matrix consists of >90 wt % PPA, e.g., >98 wt %.

Polyphthalamide (PPA) may be selected from a polymer having general formula (I), a polymer having general formula (II), a polymer composed of a combination of units of formulae (I) and (II) in the same polymer chain and a mixture thereof:

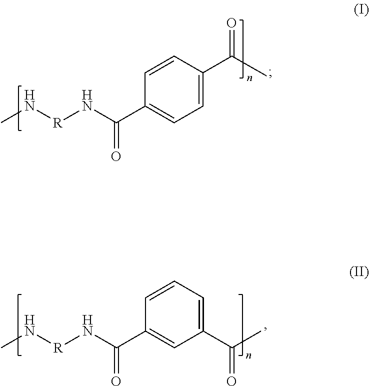

wherein n is an integer and R is an alkylene, e.g. C₂-C₈-alkylene. For the absence of doubt, when the polyphthalamide is composed of a combination of repeating units of formulae (I) and (II) in the same polymer chain, the terminal amino group of one repeating unit is bonded to the terminal carbonyl group of another repeating unit.

It may be that the polymer matrix comprises a compound of formula (I), wherein R is C₂-C₆-alkylene. It may be that the polymer matrix comprises a compound of formula (II), wherein R is C₂-C₆-alkylene. It may be that the polymer matrix comprises a copolymer comprising a combination of repeating units of formulae (I) and (II) in the same polymer chain, wherein R is C₂-C₆-alkylene.

It may be that the composite further comprises an additional filler dispersed within the polymer matrix. It may be that the additional filler is carbonaceous filler, e.g., carbon nanotubes or carbon fibers.

In a second aspect of the invention, there is provided a composite comprising a polymer matrix and graphite dispersed within the matrix, wherein the surface area of the graphite is >10 m²/g. The inventors have found that selecting high surface area graphite provides higher thermal conductivities than either lower surface area graphite or graphene.

It may be that the graphite is expanded graphite.

The surface area of the graphite may be >12 m²/g. The surface area of the graphite may be >15 m²/g. The surface area of the graphite may be in the range from 10 to 50 m²/g. The surface area of the graphite may be in the range from 12 to 40 m²/g, e.g. 15 to 30 m²/g. The surface area of the graphite may be in the range from 20 to 40 m²/g, e.g. 20 to 30 m²/g.

The average particle size of the graphite (e.g. the D₅₀) may be <250 μm. The average particle size of the graphite (e.g. the D₅₀) may be in the range from 100 μm to 250 μm. The average particle size of the graphite (e.g. the D₅₀) may be in the range from 150 μm to 200 μm. The average particle size of the graphite (e.g. the D₅₀) may be <100 μm, e.g., <75 μm. The average particle size of the graphite (e.g. the D₅₀) may be <50 μm. The average particle size of the graphite (e.g. the D₅₀) may be in the range from 150 μm to 250 μm, e.g. 175 μm to 225 μm.

It may be that greater than 50% by weight (e.g., greater than 75% by weight, greater than 90%, or greater than 98%) of the graphite has a particle size of <250 μm. It may be that greater than 50% by weight (e.g., greater than 75% by weight, greater than 90%, or greater than 98%) of the graphite has a particle size in the range from 100 μm to 250 μm. It may be that greater than 50% by weight (e.g., greater than 75% by weight, greater than 90%, or greater than 98%) of the graphite has a particle size in the range from 150 μm to 200 μm. It may be that greater than 50% by weight (e.g., greater than 75% by weight, greater than 90%, or greater than 98%) of the graphite has a particle size <100 μm, e.g., <75 μm. It may be that greater than 50% by weight (e.g., greater than 55% by weight) of the graphite has a particle size of <50 μm. It may be that greater than 50% by weight (e.g., greater than 75% by weight, greater than 90%, or greater than 98%) of the graphite has a particle size in the range from 150 μm to 250 μm, e.g. 175 μm to 225 μm.

The average thickness of the graphite may be <100 nm. The average thickness of the graphite may be <50 nm. The average thickness of the graphite may be in the range from 10 to 100 nm, e.g. 15 to 45 nm.

It may be that greater than 50% by weight (e.g. greater than 75% by weight, greater than 90% or greater than 98%) of the graphite has a thickness <100 nm. It may be that greater than 50% by weight (e.g. greater than 75% by weight, greater than 90% or greater than 98%) of the graphite has a thickness <50 nm. It may be that greater than 50% by weight (e.g. greater than 75% by weight, greater than 90% or greater than 98%) of the graphite has a thickness in the range from 10 to 100 nm, e.g. from 15 to 45 nm.

The polymer matrix may include any one of the following polymer matrices: acrylonitrile butadienestyrene (ABS) (chemical formula (C₈H₈·C₄H₆·C₃H3_{N})ₙ); polycarbonate/acrylonitrile butadiene styrene alloys (PCABS); polybutylene terephthalate (PBT); polyphenylene oxide; polyphthalamide (PPA); polyphenylene sulfide (PPS); polyphenylene ether; modified polyphenylene ether containing polystyrene; liquid crystal polymers; polystyrene; styrene-acrylonitrile copolymer; rubber-reinforced polystyrene; poly ether ketone (PEEK); acrylic resins such as polymers and copolymers of alkyl esters of acrylic and methacrylic acid styrene-methyl methacrylate copolymer, styrene-methyl methacrylate-butadiene copolymer, polymethyl methacrylate and methyl methacrylate-styrene copolymer; polyvinyl acetate; polysulfone; polyether sulfone; polyether imide; polyarylate; polyamideimide; polyvinyl chloride; vinyl chloride-ethylene copolymer; vinyl chloride-vinyl acetate copolymer; polyimides, polyamides; polyolefins such as polyethylene; ultra-high molecular weight polyethylene; high density polyethylene; linear low density polyethylene; polyethylene napthalate; polyethylene terephthalate; polypropylene; chlorinated polyethylene; ethylene acrylic acid copolymers; polyamides; polyanilines; polypyrroles; polyurethanes; polyepoxides; epoxy resins; phenylene oxide resins; phenylene sulfide resins; polyoxymethylenes; polyesters; polyvinyl chloride; vinylidene chloride/vinyl chloride resins; vinyl aromatic resins such as polystyrene; poly(vinylnaphthalene); poly(vinyltoluene); polyimides; polyaryletheretherketone; polyetheretherketones; and polyaryletherketone, or a mixture of copolymer thereof.

The matrix may comprise an aromatic polymer. The inventors have surprisingly found that composites comprising an aromatic polymer matrix provide excellent thermal conductivity.

The matrix may comprise polyphenylene sulfide (PPS). The matrix may comprise a phenyl ether polymer. The phenyl ether polymer may comprise polyphenyl ether (PPE) or poly(p-phenylene oxide) (PPO). The matrix may comprise polystyrene. The matrix may comprise a blend, e.g. an amorphous blend, of a phenyl ether polymer and polystyrene. The matrix may comprise a blend, e.g. an amorphous blend, of a polyphenyl ether (PPE) and polystyrene. The matrix may comprise a blend, e.g. an amorphous blend, of a polyphenyl ether (PPE) and polyphenylene sulfide (PPS). The matrix may comprise a blend, e.g. an amorphous blend, of a polyphenyl ether (PPE) and polyphthalamide (PPA).

The matrix may comprise a polyamide (nylon). The polymer matrix may comprise an aliphatic polyamide or an aromatic polyamide. The polymer matrix may comprise an aromatic polyamide (i.e. an aramid). The polymer matrix may comprise an aliphatic polyamide or a polyphthalamide. The polymer matrix may comprise an aliphatic polyamide. For example, it may be that the matrix comprises nylon 6, nylon 66, or a mixture thereof. The polymer matrix may comprise nylon 11 (PA 11). The polymer matrix may comprise a polyphthalamide (PPA). It may be that the polymer matrix comprises a compound of formula (I), wherein R is C₂-C₆-alkylene. It may be that the polymer matrix comprises a compound of formula (II), wherein R is C₂-C₆-alkylene. It may be that the polymer matrix comprises a copolymer comprising a combination of repeating units of formulae (I) and (II) in the same polymer chain, wherein R is C₂-C₆-alkylene.

The polymer matrix may comprise a crystalline polymer. The polymer matrix may comprise a semi-crystalline polymer. The polymer matrix may comprise a thermoplastic polymer, a thermosetting polymer or an elastomer. The polymer matrix may comprise a thermoplastic polymer. The polymer matrix may comprise a homopolymer or a copolymer.

It may be that the wt % of the graphite in the polymer matrix is <70 wt %. It may be that the wt % of the graphite in the polymer matrix is <50 wt %. It may be that the wt % of the graphite in the polymer matrix is in the range from 25 wt % to 70 wt %. It may be that the wt % of the graphite in the polymer matrix is in the range from 20 wt % to 55 wt %, e.g. from 25 wt % to 50 wt %. It may be that the wt % of the graphite in the polymer matrix is from 20 wt % to 40 wt %, e.g. from 25 wt % to 35 wt %. It may be that the wt % of the graphite in the polymer matrix is <30 wt %. It may be that the wt % of the graphite in the polymer matrix is from 5 wt % to 25 wt %, e.g. from 10 wt % to 20 wt %.

It may be that the wt % of the polymer matrix is from 50 wt % to 90 wt %. It may be that the wt % of the polymer matrix is from 55 wt % to 75 wt %. Alternatively, it may be that the wt % of polymer matrix is from 75 wt % to 85 wt %.

It may be that the composite further comprises an additional filler dispersed within the polymer matrix. It may be that the additional filler is carbonaceous filler, e.g., carbon nanotubes or carbon fibers. It may be that the additional filler is graphene. The graphene may be as defined above in relation to the first aspect of the invention.

In embodiments where the composite comprises graphite and graphene dispersed within the polymer matrix, it may be that the wt % of the graphene in the polymer matrix is <15%. It may be that the wt % of the graphene in the polymer matrix is <10%. It may be that the wt % of the graphene in the polymer matrix is from 2% to 8%, e.g. from 3% to 7%.

### Solar Thermal Collector

In a third aspect of the invention is provided a solar thermal collector comprising a composite according to the first or second aspect.

It may be that the solar thermal collector comprises a hollow body having a lower wall, an upper wall and lateral side walls and an internal cavity within said hollow body for receiving a heat exchange medium, wherein at least a portion of the upper wall is formed from a composite according to the first or second aspect.

### Optically Transmissive Panel

The solar thermal collector may further comprise an optically transmissive panel located above the upper wall of the body. The optically transmissive panel may comprise a glass, polycarbonate or PMMA glazing. The upper wall of the body and the optically transmissive panel may form an air gap therebetween. The upper wall of the body and the optically transmissive panel may form a vacuum therebetween. The solar thermal collector will still be effective irregardless of whether the upper wall of the body and the optically transmissive panel form an air gap or a vacuum therebetween. The upper wall may comprise a series of integrally formed vertically extending ribs or projections that support the optically transmissive panel. At least a portion of the upper surface of the optically transmissive panel may be abraded to reduce reflectivity thereof.

### Heat Exchange Medium

The heat exchange medium will typically be a liquid. The heat exchange medium may be selected from water, glycol, oils, or a combination thereof. It may be that the heat exchange medium is water. It may be that the heat exchange medium is a mixture of water and glycol.

### Cavity

A plurality of flow diverter baffles or vanes may be located within the internal cavity of the solar thermal collector for directing the flow of the heat exchange medium. The plurality of flow diverter baffles or vanes may direct the flow of the heat exchange medium in a direction substantially perpendicular to two of the lateral side walls of the body. It may be that the flow diverter baffles or vanes are formed from a corrugated sheet inserted within the cavity of the body, said corrugated sheet having corrugations arranged perpendicular to two of the lateral side walls of the body. The peaks of at least some of the corrugations of the corrugated sheet may be adhered to the upper wall of the body.

### End Caps

The solar thermal collector may further comprise one or more end caps for closing the open ends of the hollow body. The end caps may include at least one port for delivering a heat transfer liquid into or out of the cavity with the body of the collector. At least one of the end caps may be provided with one or more drain holes for preventing the accumulation of external liquid within the air gap formed between the upper wall of the body and the optically transmissive panel.

### Thermally Insulating Material

It may be that a layer of thermally insulating material is applied to at least the lower wall of the hollow body. The layer of thermally insulating material may extend around to at least a lower portion of the lateral sides of the hollow body. The thermally insulating material may comprise polyurethane foam, mineral wool, fiberglass or another insulating material.

The invention may be as described in one of the following numbered paragraphs:

1. A composite comprising a polyphthalamide (PPA) matrix and graphitic carbon dispersed within the PPA matrix.
2. A composite according to paragraph 1, wherein the graphitic carbon is graphite.
3. A composite according to paragraph 2, wherein the graphite is expanded graphite.
4. A composite according to paragraph 2 or paragraph 3, wherein the surface area of the graphite is >10 m²/g.
5. A composite according to paragraph 4, wherein the surface area of the graphite is >12 m²/g.
6. A composite according to any preceding paragraph, wherein the average particle size of the graphite is from 100 μm to 250 μm.
7. A composite according to any one of paragraphs 2 to 5, wherein the average particle size of the graphite is <100 μm.
8. A composite according to any one of paragraphs 2 to 7, wherein the average thickness of the graphite is in the range from 10 to 100 nm.
9. A composite according to any one of paragraphs 2 to 8, wherein the composite comprises graphite and graphene dispersed within the PPA matrix.
10. A composite according to paragraph 9, wherein the wt % of the graphene in the PPA matrix is <10%.
11. A composite according to paragraph 1, wherein the graphitic carbon is graphene.
12. A composite according to any preceding paragraph, wherein the wt % of the graphitic carbon in the PPA matrix is <65 wt %.
13. A composite according to paragraph 12, wherein the wt % of the graphitic carbon in the PPA matrix is in the range from 20 wt % to 55 wt %.
14. A composite comprising a polymer matrix and graphite dispersed within the matrix, wherein the surface area of the graphite is >10 m²/g.
15. A composite according to paragraph 14, wherein the graphite is expanded graphite.
16. A composite according to paragraph 14 or paragraph 15, wherein the surface area of the graphite is >15 m²/g.
17. A composite according to any one of paragraphs 14 to 16, wherein the average particle size of the graphite is from 100 μm to 250 μm.
18. A composite according to any one of paragraphs 14 to 16, wherein the average particle size of the graphite is <100 μm.
19. A composite according to any one of paragraphs 14 to 18, wherein the average thickness of the graphite is in the range from 10 to 100 nm.
20. A composite according to any one of paragraphs 14 to 19, wherein the composite comprises graphite and graphene dispersed within the PPA matrix.
21. A composite according to paragraph 20, wherein the wt % of the graphene in the PPA matrix is <10%.
22. A composite according to any one of paragraphs 14 to 21, wherein the wt % of the graphite in the matrix is <65 wt %.
23. A composite according to any one of paragraphs 14 to 22, wherein the polymer matrix comprises a polyamide.
24. A composite according to paragraph 23, wherein the polymer matrix comprises a polyphthalamide.
25. A solar thermal collector comprising the composite of any preceding paragraph.
26. A solar thermal collector according to paragraph 25 comprising a hollow body having a lower wall, an upper wall and lateral side walls and an internal cavity within said hollow body for receiving a heat exchange medium, wherein at least a portion of the upper wall is formed from the composite.

### BRIEF DESCRIPTION OF THE DRAWINGS

Embodiments of the invention are further described hereinafter with reference to the accompanying drawings, in which:

FIG. 1 is an exemplary solar thermal collector with a hollow body having a lower wall (1), an upper wall (2) and lateral side walls (3) and an internal cavity (4) within said hollow body for receiving a heat exchange medium. The solar thermal collector also has flow diverters (baffles) (7). At least a portion of the upper wall is formed from a composite of the present invention.

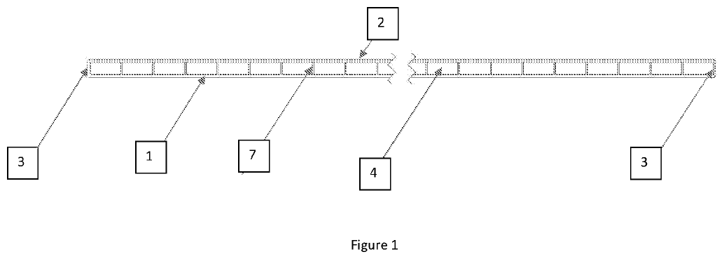

FIG. 2 is an exemplary solar thermal collector containing all the features described in FIG. 1 and further containing an optically transmissive panel (5) located above the upper wall (2) of the hollow body, the upper wall of the body and the optically transmissive panel forming an air gap (6) therebetween. The solar thermal collector also has a layer of thermally insulating material (10) applied to the lower wall of the hollow body.

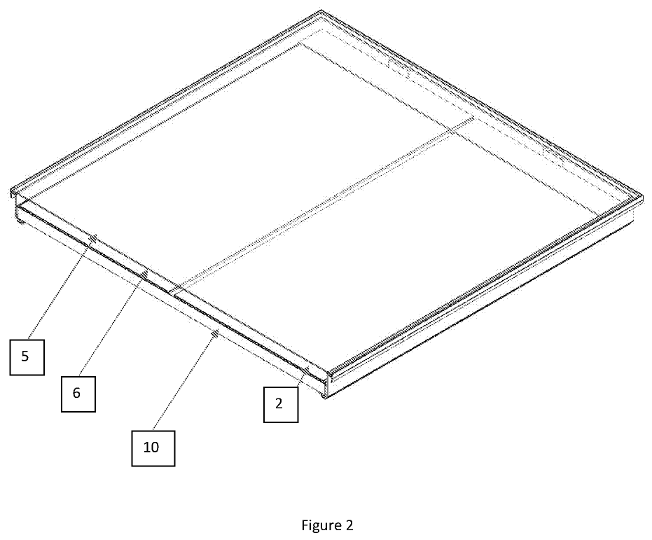

FIG. 3 is an exemplary solar thermal collector containing all the features described in FIG. 1 and further containing end caps (8) for closing the open ends of the hollow body. The end caps include a port (9) for delivering a heat transfer liquid into or out of the cavity with the body of the collector.

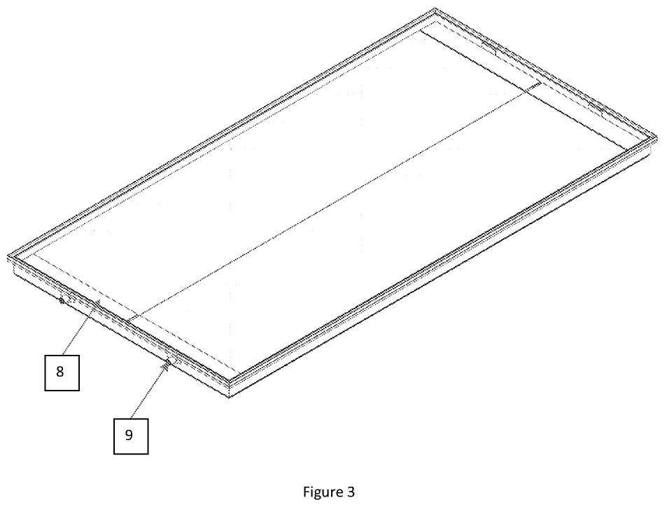

### DETAILED DESCRIPTION

The term “polyphthalamide (PPA) matrix” is intended to cover a polymer matrix consisting of at least 50% PPA.

The term “graphitic carbon” is intended to cover carbon allotropes consisting of one or more planar layers of sp²-hybridised carbon atoms packed into a two-dimensional (2D) honeycomb lattice. If two or more layers are present, then these layers are stacked on top of each other. Typically, “graphene” consists of 10 layers or less stacked on top of each other. Thus for the purposes of this specification, “graphite” is considered to be a planar graphitic species more than 10 layers thick and “graphene” is considered to be a planar graphitic species 10 layers thick or less.

The term “expanded graphite” refers to modified flake graphite with an interlayer (interplanar) spacing greater than that of conventional flake graphite. For example, it may be that expanded graphite has an average interplanar spacing of >0.335 nm.

The surface area of graphitic carbon, e.g. graphite, may be calculated using techniques known in the art. For example, by quantifying the amount of gas, e.g., nitrogen gas, adsorbed by a sample of graphitic carbon and using the BET theory to calculate the surface area (known as the BET method). The BET method is an international standard recognised by the ISO (ISO 9277:2022). The term “surface area” used herein may therefore be the BET surface area (i.e. the surface area calculated using the BET method).

The “average particle size” may be the median particle size (or median particle diameter), i.e. the particle size of which approximately 50% of the particles are smaller in size than and approximately 50% of the particles are larger in size than, commonly referred to as the D₅₀. For example, graphite having a D₅₀ of 200 μm means that approximately 50% of the graphite particles are smaller in size than 200 μm (and approximately 50% of the graphite particles are larger in size than 200 μm). The term “average particle size” used herein may therefore be the D₅₀.

D₅₀ may be measured by methods well known in the art. A common method is particle size screening by laser diffraction (this technique is an international standard recognised by the ISO; ISO 13320:2020). Laser diffraction provides a particle size of which approximately 50% by volume of the particles are smaller in size than (since this technique assumes a spherical particle shape in its optical mode). This may be referred to as the D_{V}50. Alternatively, for larger particles, e.g. having a particle size of >150 μm, particle size (D₅₀) may also be determined by sieving (see, e.g. R. A. Meyers, Encyclopedia of Analytical Chemistry, Wiley, 2000). This provides a particle size of which approximately 50% by weight of the particles are smaller in size than.

The term “aromatic polymer” is intended to cover any polymer comprising a repeating unit that comprises an aromatic ring system (i.e. a ring system containing 2 (2n+1)π electrons). Typically, aromatic polymers comprise a repeating unit that comprises a phenyl ring. Examples of aromatic polymers include polyphthalamide (PPA), polyphenylene sulfide (PPS), polyphenyl ether (PPE) and poly(p-phenylene oxide) (PPO).

For the absence of doubt, the term “polyamide” and “nylon” are used interchangeably in this specification.

For the absence of doubt, “nylon 6” has the following structure:

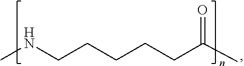

wherein n as in integer.

For the absence of doubt, “nylon 66” has the following structure:

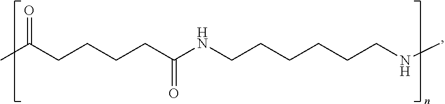

wherein n as in integer.

For the absence of doubt, “nylon 11” has the following structure:

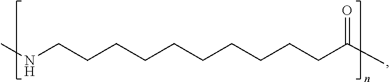

wherein n as an integer.

The term “alkylene” refers to a bivalent linear or branched saturated hydrocarbon chain. For example, “C₂-C₆-alkylene” may refer to ethylene, n-propylene, iso-propylene, n-butylene, sec-butylene, tert-butylene, n-pentylene or n-hexylene.

The term “heat exchange medium” is intended to cover any substance that can store heat in a reversible form and that can be circulated around a heating system.

The term “upper wall” used to define the solar thermal collector of the third aspect equates to the upwards facing wall of the collector when the solar collector is in normal use, i.e. the wall that would face in the direction of the sun when the solar collector is in normal use. The “lower wall” equates to the wall opposite the upper wall, i.e. the wall that would face in the opposite direction to the sun when the solar collector is in normal use. The logic same applies to the “upper surface” of the optically transmissive panel, i.e., the surface that would face in the direction of the sun when the solar collector is in normal use.

The upper wall may comprise a series of integrally formed vertically extending ribs or projections that support the optically transmissive panel. The term “vertically” used in this context is intended to mean substantially perpendicular to the upper surface of the upper wall, the upper surface of the upper wall being the surface of the upper wall that would face in the direction of the sun when the solar collector is in use.

For the absence of doubt, unless stated otherwise, wt % is the weight % of the specified component relative to the total weight of the composite.

The composites of the present invention may be used in a heat exchanger. Heat exchangers are used to transfer heat from one medium to another. The media may be a gas, liquid, or a combination of both. Heat exchangers can improve the energy efficiency of certain systems by redistributing (transferring) heat from an area where it is not need to an area of the system where it can be usefully used.

Heat exchangers have a number of applications, such as in battery packaging and powertrains, under the hood electronics, automotive lighting, home heat recovery in heating, ventilation, and air conditioning (HVAC), industrial heat recovery, applications using sea water or greywater, general electrical and electronics, e.g. thermal management of motherboards and chips, in healthcare and in aerospace. The heat exchanger may be a heat sink.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

### Examples

The composites of the present invention can be manufactured according to the following procedure.

### Preparation of Composites: Compounding

Prior to manufacture, the polymer, e.g. PPA, graphitic carbon and any additives are dried in a desiccant or oven dryer at 100° C. for upwards of 8 hours, e.g. for 24 hours.
The polymer is then ground to a powder on a micron level via a freezer mill using liquid nitrogen for ˜20 minutes.
The polymer and fillers (graphitic carbon and any additives) are then dried again for 24 hours.
The polymer and fillers are dry mixed at ˜2000 rpm for 5 minutes.
Within less than a day, the dry mixture is directly fed into a co-rotating twin screw extruder for compounding the material, with temperatures in the range of 300-340° C.
The extrude is cooled by passing it through a water bath as per typical industrial methods known in the art associated with the base polymer.
The extrude is then pelletised as per typical procedures known in the art, collected and stored.
Prior to any further use, samples are dried again.
Composites can then be moulded by compression moulding, extrusion moulding or injection moulding. A method of compression moulding is described below.

It is critical that during compounding moisture levels within the polymer are kept to a minimum (ideally <0.1%). This may be done, e.g. by drying in a desiccant oven and drying samples again before moulding.

### Preparation of Composites: Compression Moulding

The compression moulding machine is pre-heated to within 300-340° C.
The composite pellets are placed into a 50 mm diameter disc shaped compression mould, enabling a finished sample thickness of just under 2.5 mm. Pre-heating takes several minutes.
The plattens are closed to approximately 1 Bar pressure maintained for approximately 10 minutes to facilitate polymer melting.
Following this, 100 bar pressure is applied for approximately 25 minutes to enable full consolidation.
Cooling of the plattens takes place at 20° C. per minute to 50° C. prior to sample removal.
Sample conditioning then takes place based on the subsequent relevant test procedure.
   It will be evident to those skilled in the art that certain parameters, e.g. the temperature of the twin screw extruder, will be determined by the specific polymer used.

### Preparation of Polyphenylene Sulfide (PPS) Composites

As a further specific example, the preparation of a composite comprising PPS is described below. The PPS used was a Solvay Ryton XE3500BL.

PPS Compounding: prior to compounding, 86 wt % PPS, 10 wt % SGL and 4 wt % PG50 were dried in a Memmert oven to a measured moisture content of 0.01-0.02%. Compounding took place on a high temperature twin screw extruder: Eur.ex.ma E Lab 22. The approximate temperature profile from feed (left) to Nozzle (right) were:

| Temperatures ° C. | Screw Speed (rpm) |
|---|---|
| 280, 290, 320, 320, 330, 340, 340, 340 | 150 |

Injection Moulding Specimens: Injection moulding of samples took place on an Arburg AllRounder 370A with 30 mm screw diameter. Settings remained relatively constant other than injection pressure to achieve relative comparisons:

| | Virgin | Composite |
|---|---|---|
| Injection Pressure (bar) | 1340 | 1790 |
| Feed Zone 1 (° C.) | 290 | 290 |
| Zone 2 (° C.) | 300 | 300 |
| Zone 3 (° C.) | 305 | 305 |
| Zone 4 (° C.) | 310 | 310 |
| Nozzle (° C.) | 320 | 320 |
| Mould Temperature (° C.) | 145 | 145 |

### Measuring Thermal Conductivity

The thermal conductivity of the composites obtained by the procedures outlined above can be measured according to the to the ASTM E1530 method; a standard test method for evaluating the resistance to thermal transmission by the guarded heat flow meter technique. This method is commonly used in the art to measure thermal conductivity.

### Thermal Conductivity Data

Certain composites according to the present invention were manufactured according to the above-mentioned method described in ‘Preparation of Composites: Compounding’ and ‘Preparation of Composites: Compression Moulding’, above. The thermal conductivity of these composites was then measured according to the above-mentioned method. The results can be seen in Tables 1 and 2, below.

TABLE 1

| | Through Thickness Thermal |
|---|---|
| Wt % of graphitic carbon | Conductivity (W/mK) at |
| in the polymer matrix | Varying Filler Loadings |

| Polymer | Graphitic carbon | 30 | 40 | 60 |
|---|---|---|---|---|
| PPA | SEGF | 2.89 | 4.00 | 9.72 |
| PPA | EG | 1.95 | 2.61 | 5.30 |
| PPA | SGL | 4.35 | — | — |

TABLE 2

| | | | | Through Thickness |
|---|---|---|---|---|
| | | | | Thermal |
| | | wt % | wt % | Conductivity |
| Composite | Polymer | graphite | graphene | (W/mK) |
| 1 | PPA | 15% SGL | 5% PG50 | 1.2-1.4 |
| 2 | PPA | 30% SGL | 5% PG50 | 4.9-5.1 |
| 3 | Polypropylene | 30% SGL | 5% PG50 | 1.04 |

In all tested PPA composites, the PPA polymer used was the base resin DuPont™ Zytek® HTN FE8200. The polypropylene in the polypropylene composite was Moplen EP 440G.

The graphitic carbon used in each composite can be seen in the table below.

| | | | | | BET | |
|---|---|---|---|---|---|---|
| | Graphitic | | Particle | | Surface | |
| Abbreviation | carbon | Manufacturer | size | | area | |
| SEGF | Surface | Asbury | 55% <45 | μm | 17.3 | m²/g |
| | enhanced | | | | | |
| | graphite | | | | | |
| | flake | | | | | |
| EG | Expanded | Asbury | <75 | μm | | |
| | graphite, | | | | | |
| | Grade | | | | | |
| | 3538 | | | | | |
| SGL | Expanded | SGL | 200 | μm | 25 | m²/g |
| | graphite | Carbon | | | | |

| | | | | | |
|---|---|---|---|---|---|
| PG50 | Graphene | First | 200 | μm | — |
| | | Graphene | | | |

1. A composite comprising a polymer matrix and graphite dispersed within the matrix, wherein the surface area of the graphite is >10 m²/g.

2. The composite according to claim 1, wherein the graphite is expanded graphite.

3. The composite according to claim 1, wherein the surface area of the graphite is >15 m²/g.

4. The composite according to claim 1, wherein the composite also comprises graphene dispersed within the polymer matrix.

5. The composite according to claim 4, wherein the wt % of the graphene in the polymer matrix is <10%.

6. The composite according to claim 1, wherein the wt % of the graphite in the matrix is <65 wt %.

7. The composite according to claim 1, wherein the wt % of the graphite in the matrix is in the range from 20 wt % to 55 wt %.

8. The composite according to claim 1, wherein the average particle size of the graphite is from 100 μm to 250 μm.

9. A composite according to claim 1, wherein the average particle size of the graphite is <100 μm.

10. The composite according to claim 1, wherein the average thickness of the graphite is in the range from 10 to 100 nm.

11. The composite according to claim 1, wherein the polymer matrix comprises an aromatic polymer.

12. The composite according to claim 1, wherein the polymer matrix comprises a polyphthalamide (PPA).

13. The composite according to claim 1, wherein the polymer matrix comprises either polyphenylene sulfide (PPS) or an amorphous blend of a polyphenyl ether (PPE) and polystyrene.

14. A composite comprising a polyphthalamide (PPA) matrix and graphitic carbon dispersed within the PPA matrix.

15. The composite according to claim 14, wherein the graphitic carbon is graphite.

16. The composite according to claim 15, wherein the graphite is expanded graphite.

17. The composite according to claim 15, wherein the surface area of the graphite is >10 m²/g.

18. The composite according to claim 17, wherein the surface area of the graphite is >12 m²/g.

19. The composite according to claim 15, wherein the composite also comprises graphene dispersed within the PPA matrix.

20. The composite according to claim 19, wherein the wt % of the graphene in the PPA matrix is <10%.

21. The composite according to claim 14, wherein the wt % of the graphite in the PPA matrix is <65 wt %.

22. The composite according to claim 14, wherein the wt % of the graphite in the PPA matrix is in the range from 20 wt % to 55 wt %.

23. The composite according to claim 14, wherein the average particle size of the graphite is from 100 μm to 250 μm.

24. The composite according to claim 14, wherein the graphitic carbon is graphite and the average particle size of the graphite is <100 μm.

25. The composite according to claim 14, wherein the graphitic carbon is graphite and the average thickness of the graphite is in the range from 10 to 100 nm.

26. A solar thermal collector comprising the composite of claim 1.

27. The solar thermal collector according to claim 26 comprising a hollow body having a lower wall, an upper wall and lateral side walls and an internal cavity within said hollow body for receiving a heat exchange medium, wherein at least a portion of the upper wall is formed from the composite.
